(19) United States
(12) Patent Application Publication
(10) Pub. No.: US 2018/0185749 A1
(43) Pub. Date: Jul. 5, 2018

(54) Multi-Functional Game Controller Device with Interchangeable Finger Actuatable Members and Function Panels

(71) Applicant: Michael Kidakarn, City of Industry, CA (US)

(72) Inventor: Michael Kidakarn, City of Industry, CA (US)

(21) Appl. No.: 15/861,928

(22) Filed: Jan. 4, 2018

Related U.S. Application Data
(60) Provisional application No. 62/442,575, filed on Jan. 5, 2017.

(51) Int. Cl. A63F 13/24; A63F 13/22

(52) U.S. Cl. CPC A63F 13/24; A63F 13/235; A63F 13/22

(57) ABSTRACT

A multi-functional game controller device with interchangeable finger actuatable members and function panels operatively connects to a game console. The game controller comprises a hand held housing forming a socket. An input signal contact member in the socket is operable to transmit a signal to the game console. Multiple interchangeable finger actuatable members having buttons or switches selectively engage and disengage the input signal contact member, such that finger actuation of the button or switch transmits signals to the game console. Each finger actuatable member is different to provide different functions, and operate with different video games. Multiple functions panels overlay the finger actuatable members. The function panels comprise a flanged perimeter that detachably couples function panels to the game controller housing. The function panels comprise a surface defined by indicia that aligns with a button or switch to identify a function for a correlating button or switch.

### CROSS REFERENCE OF RELATED APPLICATIONS

This application claims the benefits of U.S. provisional application No. 62/442,575, filed Jan. 5, 2017 and entitled CONFIGURABLE GAME CONTROLLER ASSEMBLY, which provisional application is incorporated by reference herein in its entirety.

### FIELD OF THE INVENTION

The present invention relates generally to a multi-functional game controller device with interchangeable finger actuatable members and function panels. More so, a game controller device provides a game controller operatively connected to a game console for playing a video game whereby the game controller comprises a hand held housing forming a socket that contains an input signal contact member operable to transmit a signal to the game console; whereby multiple interchangeable finger actuatable members having buttons or switches selectively engage the input signal contact member; whereby finger actuation of the button or the switch transmits the signal to the game console; whereby each finger actuatable member is different, so as to provide different functions and be operable with different video games; whereby multiple functions panels overlay the finger actuatable members; whereby the function panels comprise a flanged perimeter that detachably couples the function panel to the housing of the game controller; whereby the function panels comprise a surface defined by indicia that aligns with a button or switch to identify a function for a correlating button or switch.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, gaming devices and computers require an interface through which commands are input. The nature of these inputs necessarily defines the range of commands that the user can give to the system. A game controller, or control pad, is an input device that may be used to provide an input to a video game console, personal computer system, or the like, to control a video game, computer game, or the like.

Often, the game controller can be a gamepad, joystick, mouse, keyboard, or any other device designed for gaming that can receive input. Special purpose devices, such as steering wheels for driving games and light guns for shooting games, may also exist for a platform. Typically, game controllers are defined by a predetermined set up or location for the separate controls. However, the control devices of traditional computer or video games are generally fixed to their chassis which cannot be removed and replaced by a user.

Typically, industry standard game controllers provides only a limited number of inputs: at least two buttons, a power switch, and a volume dial. The number of game controllers that can be plugged into a conventional game console is also limited, to one. Further, the standard game controller has to be changed to accommodate the large number of video games available.

Other proposals have involved game controllers operational with game consoles. The problem with these game controllers is that they do not provide multiple arrangements of buttons and switches on the same game controller housing. Also, the labels remain static, and do not adapt to the different types of games. Even though the above cited game controllers meet some of the needs of the market, a multi-functional game controller device with interchangeable finger actuatable members and function panels operatively connects to a game console for playing a video game, is still desired.

### SUMMARY

Illustrative embodiments of the disclosure are generally directed to a multi-functional game controller device with interchangeable finger actuatable members and labeled function panels. The multi-functional game controller device provides input to a video game, typically to control an object or character in the game. The game controller is operatively connected to a game console for playing a video game.

In some embodiments, the game controller comprises a hand held housing forming a socket that contains an input signal contact member operable to transmit a signal to the game console. Multiple interchangeable finger actuatable members having buttons or switches selectively engage the input signal contact member, such that finger actuation of the button or the switch transmits the signal to the game console. Further, each finger actuatable member is different, so as to provide different functions and be operable with different video games.

In some embodiments, multiple functions panels overlay the finger actuatable members. The function panels comprise a flanged perimeter that detachably couples the function panel to the housing of the game controller. The function panels comprise a surface defined by indicia that aligns with a button or switch to identify a function for a correlating button or switch.

In one aspect, a multi-functional game controller device with interchangeable finger actuatable members and labeled function panels, comprises:
a game controller operatively connected to a game console, the game controller defined by a housing, the housing having sidewalls forming at least one socket;
an input signal contact member disposed in the socket, the input signal contact member operable to transmit a signal to the game console;
a first finger actuatable member detachably inserted in the socket, the first finger actuatable member comprising at least one button, or at least one switch, or both, the button or the switch having a first contact panel being selectively engaged with the input signal contact member, dependent on finger actuation of the button or the switch of the first finger actuatable member,
whereby finger actuation of the button or the switch transmits the signal to the game console;
a first contact panel operatively connected to the button or switch of the first finger actuatable member, the first contact panel selectively engaging and disengaging the input signal contact member in the socket, dependent on finger actuation of the button or the switch of the first finger actuatable member, whereby the first contact panel actuates the input signal contact member to transit the input signal when engaging the input signal contact member;
a second finger actuatable member detachably inserted in the socket, the second finger actuatable member comprising at least one button, or at least one switch, or both, the button or the switch having a second contact panel being selectively engaged with the input signal contact member, dependent on finger actuation of the button or the switch of the second finger actuatable member,
whereby finger actuation of the button or the switch of the second finger actuatable member transmits the signal to the game console;
a plurality of function panels detachably overlaying the housing of the game controller, the function panels defined by a flanged perimeter and a surface forming an opening, the flanged perimeter detachably coupling the function panels to the housing of the game controller, the opening enabling access to the button or the switch of the first finger actuatable member and the second finger actuatable member; and
at least one indicia disposed on the surface of the function panels, the indicia generally aligned with the button or the switch of the first or second finger actuatable member, the indicia identifying a function for a correlating button or switch

In another aspect, the housing is defined by a generally cross shape.

In another aspect, the device further comprises at least one joystick.

In another aspect, the device further comprises a rear finger actuatable member disposed in the housing, opposite the first finger actuatable member. The rear finger actuatable member is selectively engaged with the input signal contact member, dependent on finger actuation. In this manner, finger actuation of the rear finger actuatable member transmits the signal to the game console.

In another aspect, the first finger actuatable member and the rear finger actuatable member include at least one of the following: a rear joystick, an analogue control stick, an adjustable tension stick, a bumper, a track ball, a switch, a trigger, a mouse, a steering wheel, a light gun, a keyboard, and a peripheral that selectively engages and disengages the input signal contact member in the socket.

In another aspect, the input signal contact member comprises an electrically conductive strip of metal.

In another aspect, the indicia on the surface of the function panel includes at least one of the following: a graphical image, a color, a pattern, a texture, a text, and an alphanumeric digit.

In another aspect, the flanged perimeter of the function panels has a friction fit relationship with the socket forming in the housing of the game controller.

In another aspect, the engagement between the input signal contact member and the first contact panel closes an electrical circuit.

In another aspect, the device also includes a second finger actuatable member that is detachably inserted in the socket. The second finger actuatable member may include at least one button, or at least one switch. The button or the switch of the second finger actuatable member includes a second contact panel that selectively engages the input signal contact member, dependent on finger actuation of the button or the switch of the second finger actuatable member. In this manner, finger actuation of the button or the switch of the second finger actuatable member transmits the signal to the game console.

In another aspect, the device also includes a third finger actuatable member and a fourth finger actuatable member.

In another aspect, the button and switch arrangement for the first, second, third, and fourth finger actuatable members is different.

In another aspect, the game console is a video game console having a library of video games.

One objective of the present invention is to provide a game controller that has interchangeable buttons and switches, and labeled panels that identify the functions of the buttons and switches.

Another object of the present invention is to provide a game controller adapted for operation with a video game console that allows a user to configure the game controller, or control pad, in a desired manner.

Another object of the present invention is to provide a game controller with removable finger actuatable members that can couple to the control pad in different combinations and locations.

Yet another object of the present invention is to provide a game controller that can identify different types of finger actuatable members regardless of the socket in which the finger actuatable member has been positioned.

Yet another object of the present invention is to provide multiple labeling options for the various finger actuatable members.

Yet another object of the present invention is to snap lock the finger actuatable member into the housing with a function panel having a flanged perimeter.

Yet another object of the present invention is to provide a universal game controller that is operable with different types of game consoles.

Yet another object of the present invention is to provide an inexpensive method to manufacture game controller.

Yet another object of the present invention is to provide an easy to operate game controller that does not require an advanced gaming skill set to master.

Yet another object of the present invention is to provide an inexpensive method for an end user to maintain a functional game controller.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary multi-functional game controller device, showing a game controller and a game console, in accordance with an embodiment of the present invention;

FIG. 2 illustrates a perspective view of an exemplary game controller and a detachable first finger actuatable member, in accordance with an embodiment of the present invention;

FIG. 3 illustrates a perspective view of an exemplary game controller and a detachable second finger actuatable member, in accordance with an embodiment of the present invention;

FIG. 4 illustrates a perspective view of an exemplary game controller and a detachable third finger actuatable member, in accordance with an embodiment of the present invention;

FIG. 5 illustrates a perspective view of the game controller with the first finger actuatable member removed, in accordance with an embodiment of the present invention;

FIGS. 6A, 6B, 6C, and 6D illustrate perspective views of four different and interchangeable finger actuatable members configured to operate in the socket formed in the game controller shown in FIG. 5, with each finger actuatable member having different arrangements of buttons and switches, in accordance with an embodiment of the present invention;

FIG. 7 illustrates a rear perspective view of the game controller with first finger actuatable member with a rear finger actuatable member, in accordance with an embodiment of the present invention;

FIG. 8 illustrates a perspective view of the game controller with first finger actuatable member and a detached function panel, in accordance with an embodiment of the present invention;

FIG. 9 illustrates a perspective view of the game controller with first finger actuatable member and a detached function panel having indicia to help perform gaming functions, in accordance with an embodiment of the present invention; and

FIG. 10 illustrates an alternative embodiment of the game controller device, showing a joystick and six combinations of buttons, in accordance with an embodiment of the present invention.

Like reference numerals refer to like parts throughout the various views of the drawings.

### DETAILED DESCRIPTION OF THE INVENTION

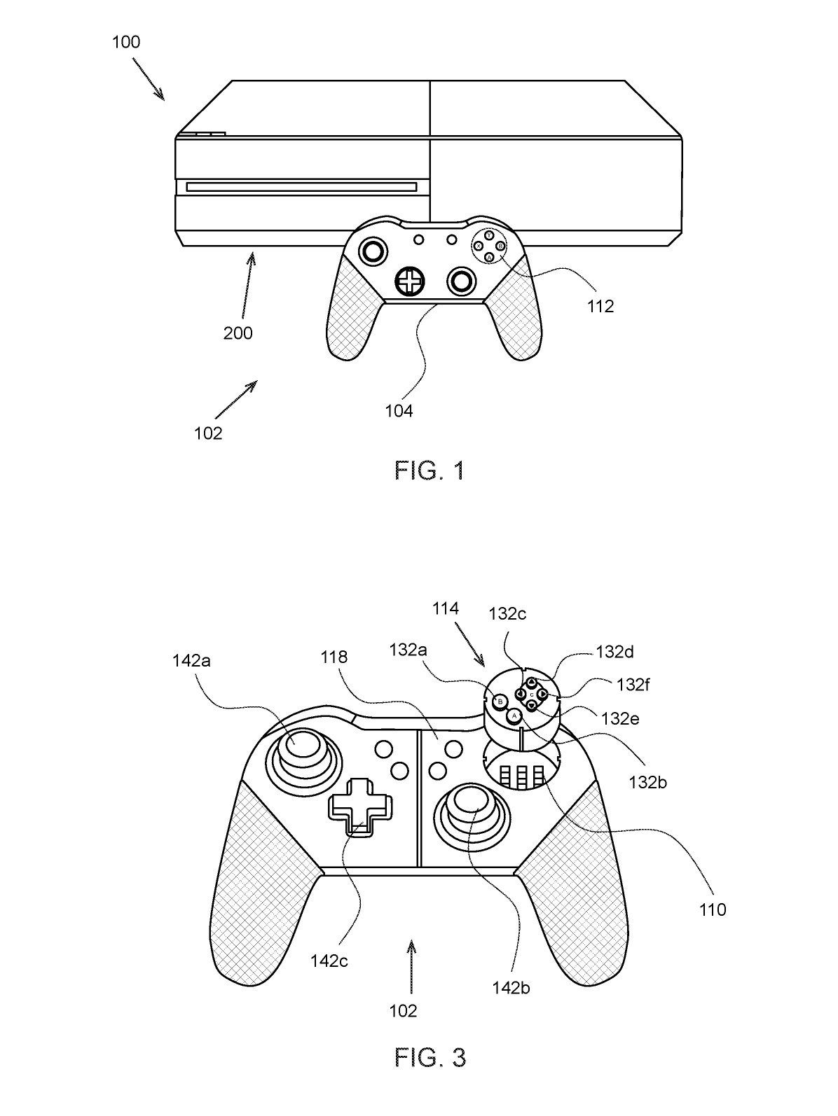

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

In one possible embodiment of the present invention presented in FIGS. 1-9, a multi-functional game controller device 100 with interchangeable finger actuatable members and labeled function panels is configured to provide a unique game controller that is operable with a game console 200 used for gaming (FIG. 1). The multi-functional game controller device 100 with interchangeable finger actuatable members and function panels, hereafter “device 100” is configured to wirelessly connect to the game console 200 for playing a video game.

The unique aspect of the device is the use of multiple interchangeable finger actuatable members having differently shaped and purposed buttons and switches. Further, multiple functions panels overlay the finger actuatable members, with each function panel having a different set of indicia that identifies the function for the buttons and switches. In this manner, myriad combinations of control means are interchangeable on the same game controller.

In one non-limiting embodiment, the game controller 102 comprises a hand held housing forming a socket 108. An input signal contact member in the socket 108 is operable to transmit a signal to the game console 200. Multiple interchangeable finger actuatable members 112, 114, 128, 138 having buttons or switches selectively engage and disengage the input signal contact member 110, such that finger actuation of the button or switch transmits signals to the game console 200. Each finger actuatable member 112, 114, 128, 138 is different to provide different functions, and operate with different video games.

Further, a plurality of functions panels 118 overlay the finger actuatable members 112, 114, 128, 138. The function panels 118 comprise a flanged perimeter that detachably couples the function panel 118 to the game controller housing 104. The function panels 118 comprise a surface 120 defined by indicia 122a-c that aligns with a button or switch to identify a function for a correlating button or switch.

Those skilled in the art will recognize that conventional controllers for most game consoles are intended to be held and operated by the user using both hands. A conventional controller will generally comprise a hard outer case with a plurality of controls mounted about the controller. Typically the controls include buttons, analogue control sticks, bumpers, and triggers.

Gaming devices and computers require an interface through which commands are input. The nature of these inputs necessarily defines the range of commands that the user can give to the system. A game controller, or control pad, is an input device that may be used to provide an input to a video game console, personal computer system, or the like, to control a video game, computer game, or the like.

Often, the game controller can be a gamepad, joystick, mouse, keyboard, or any other device designed for gaming that can receive input. Special purpose devices, such as steering wheels for driving games and light guns for shooting games, may also exist for a platform. Typically, game controllers are defined by a predetermined set up or location for the separate controls. However, the control devices of traditional computer or video games are generally fixed to their chassis which cannot be removed and replaced by a user.

As FIG. 2 illustrates, the game controller 102 comprises a housing 104 that is configured to be hand held, so as to enable fingers and thumbs to manipulate a finger actuatable member 112. The finger actuatable member 112 that detachably attaches to the housing 104 has buttons or switches configured to be manipulated, so as to generate input signals to the game console 200 that control the action of the video games.

Specifically, the finger actuatable member 112 includes buttons or switches that each have a contact panel 140 that engages an input signal contact member 110. When the contact panel 140 engages the input signal contact member 110, a circuit is closed; and thereby an input signal is transmitted to the game console 200 for operating the video game.

The game controller 102 further comprises multiple interchangeable function panels 118 that overlay the finger actuatable members. The function panels 118 are defined by a flanged perimeter 124 that securely fastens the finger actuatable members 112, 114, 128, 138 to the housing 104. The function panels 118 are labeled with at least one indicia 122a, 122b, 122c that help identify: 1) the operating functions for each finger actuatable member; 2) the playing instructions for the video game; 3) the correlation between the finger actuatable members and the video game; and 4) any number of button combinations that are specific to the finger actuatable member.

As FIG. 5 illustrates, the device 100 is configured so that any combination of finger actuatable members 112, 114, 128, 138 and function panels 118 may be operable together, depending on the type of video game being played and the desired style of play and play features of the video game.

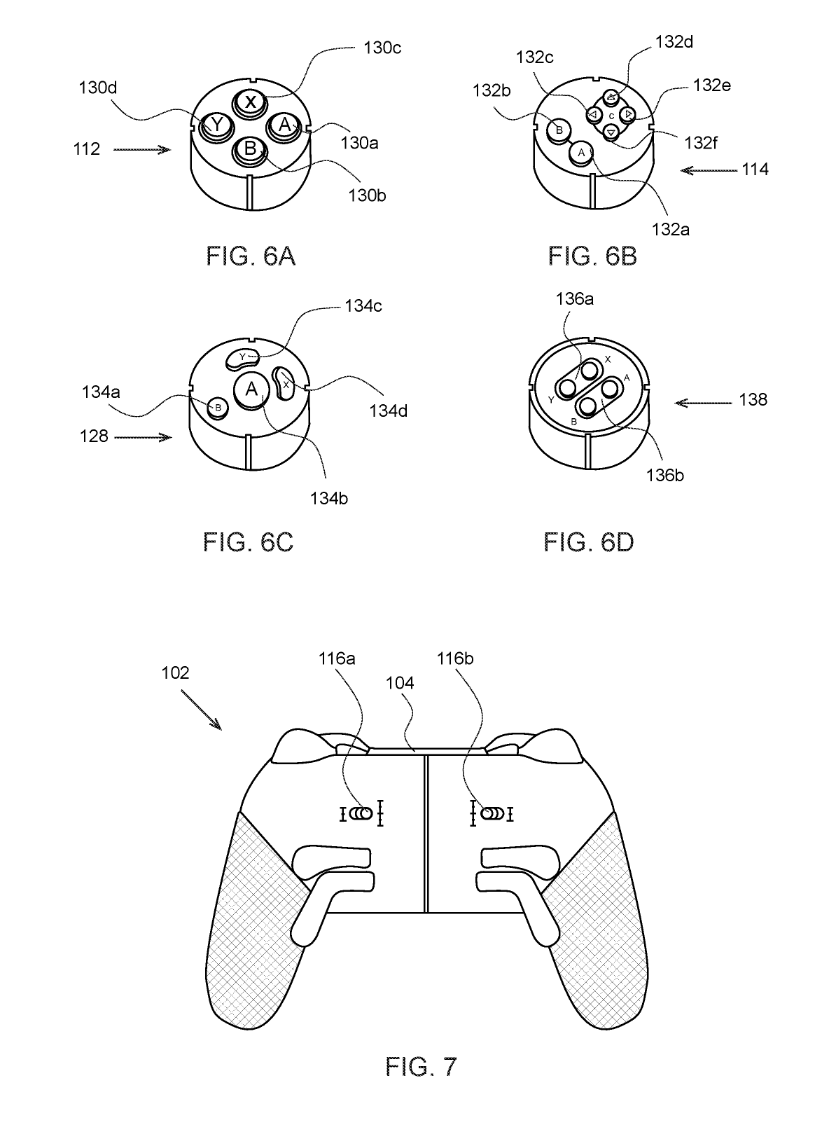

FIGS. 6A, 6B, 6C, and 6D illustrate perspective views of four different and interchangeable finger actuatable members 112, 114, 128, 138 configured to operate in the socket 108 formed in the game controller 102 shown in FIG. 5, with each finger actuatable member 112, 114, 128, 138 having different arrangements of buttons and switches. The buttons and switches provide unique functions for the video game, depending on their position and shape on the respective finger actuatable member 112, 114, 128, 138.

For example, a first finger actuatable member 112 provides four large, equally spaced-apart buttons 130a, 130b, 130c, 130d for playing a sports game (FIG. 6A). The first finger actuatable member 112 also provides a first function label 118 that numbers the four buttons 130a-d as button A 130a, button B 130b, button X 130c, and button Y 130d.

A second finger actuatable member 114 provides two large buttons 132a, 132b separated from four small equally-spaced buttons 132c-f for playing an action game (FIG. 6B). The second finger actuatable member 114 also provides a first function label that numbers the two large buttons A and B 132a-b, and the four small buttons 132c, 132d, 132e, 132f labeled as a collective C.

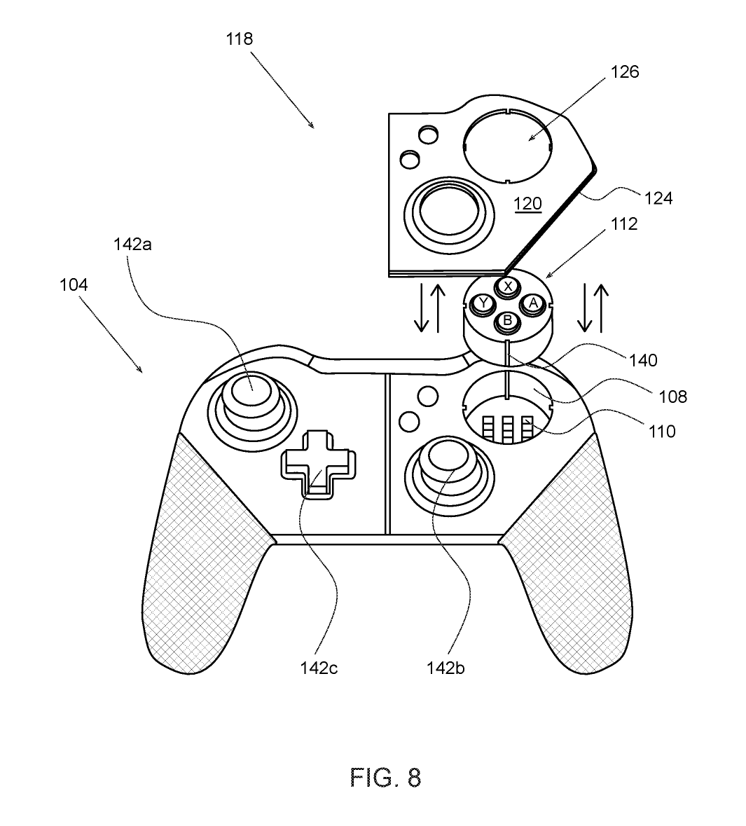

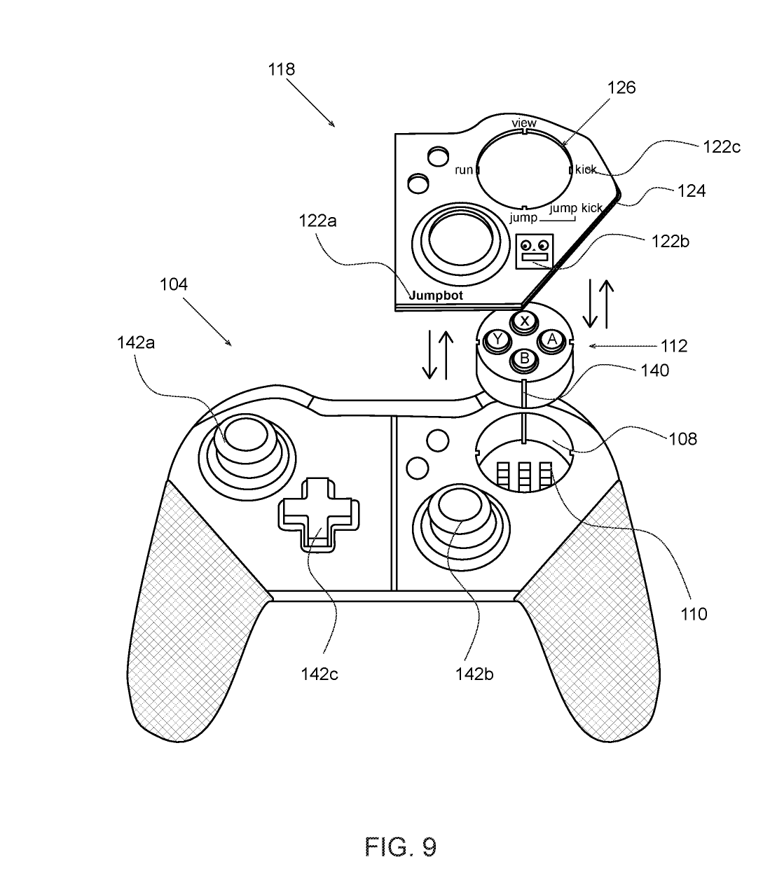

A third finger actuatable member 128 provides a central large button 134a, a side small button 134b, and two arc-shaped buttons 134c, 134d (FIG. 6C). A fourth finger actuatable member 138 provides two longitudinal switches 136a, 136b arranged in a parallel disposition (FIG. 6D). In each arrangement of buttons and switches for the finger actuatable members 112, 114, 128, 138; the contact panels 140 for each button and switch is depressed or slidably displaced to engage a corresponding input signal contact member 110, so as to actuate input signals to the game console 200 for operating the video game. In yet other embodiments, shown in FIGS. 8 and 9, at least one joystick 142a, 142b and a directional pad 142c may be used as input devices for the game controller 102.

As referenced in FIG. 1, the device 100 may include a game console 200 configured to output a video signal to display a video game. The game console 200 may include an electronic, digital or computer device that outputs a video signal or visual image to display a video game that one or more people can play.

In one non-limiting embodiment, the game console 200 is a video game console having a library of video games. In some embodiments, the game console 200 may include, without limitation, a Play Station™, a Play Station 2™, an Xbox™, a Game Cube™, a computer, and a game system that plays video games.

Turning now to FIGS. 2-4, the device 100 provides a hand-held, wireless game controller 102 that is adapted for operation with such game consoles as described above. In one embodiment, the game controller 102 includes a housing 104 configured to be hand-held, so as to enable the fingers and thumbs to provide input for playing the video game from the game console.

The housing 104 may have a generally cross shape and be fabricated from a rigid polymer. Though in some embodiments, other materials may be used. In one embodiment, the housing 104 is formed of an upper or top plastic housing 104 and a lower or bottom plastic housing 104 that snap together. Each portion of the housing 104, including the finger actuatable members, may be molded plastic, but each individual portion formed from any suitable material.

The housing 104 comprises sidewalls 106 that are defined by at least one socket 108. The socket 108 may form a generally round cavity in the housing 104. In one embodiment, only one socket 108 is used. Though in other embodiments, multiple sockets may form in the housing 104. The socket 108 is sized and dimensioned to interchangeably receive a first finger actuatable member 112 and a second finger actuatable member 114, as described below.

The device 100 may further include an input signal contact member 110 disposed in the at least one socket 108. In one embodiment, the input signal contact member 110 includes at least one strip of metal that overlays the surface of the cavity in the socket 108. The metal may include a conductive metal, such as copper. The input signal contact member 110 is configured to be actuated to close a circuit through contact with another strip of conductive metal, such as the first and second contact panels, discussed below.

Upon actuation, the input signal contact member 110 transmits an input signal to the game console 200, which is received by a processer in the game console 200. This is translated into an action in the video game. The housing 104 action panel is sufficiently sized to be engaged by multiple contact panels that are spaced-apart from each other. Each contact panel 200 engagement generates a different input signal, which then translates into a different function in the video game.

In one exemplary embodiment, the input signal contact member 110 has eight electronic contacts or pins that electrically connect or communicate with correlating electrical contacts on each button from the first or second finger actuatable member that is coupled to the socket 108. These electrical contacts may be electrically connected to a printed circuit board (PCB) module and a main PCB. Through the main PCB, the contacts are electrically coupled to a circuit or microprocessor that is able to identify which specific control device is coupled or positioned in which specific slot.

For example, actuation of a left region of the input signal contact member 110 transmits a first input signal that causes a video game action player to shoot a gun, while actuation of a right region of the input signal contact member 110 transmits a second input signal that causes the action player to jump. In any case, upon closing the electrical circuit, an input signal is transmitted to the game console.

As illustrated in FIG. 2, the device 100 may further include a first finger actuatable member 112. The first finger actuatable member 112 is configured to detachably couple to the at least one socket 108, generally by sliding into the cavity formed in the socket 108. Though in some embodiments, the first finger actuatable member 112 may have a snap-fit relationship with the socket 108. The first finger actuatable member 112 is configured, such that manipulation of the thumbs and fingers controls video game activity from the game console.

The interchangeability of the first finger actuatable member 112 provides numerous advantages for gaming and maintenance of the device 100. For example, replacement parts are more easily obtained. It is known in the art that when playing games intensely the buttons and switches may break, and the mechanical moveable components may fail. Thus, by providing switchable button parts, the player can more easily replace the broken first finger actuatable member 112—even during a game—rather than the entire device 100. This saves both time and money for the user.

Thus, when playing games competitively and participating in timed race competitions, replaceable button parts and replaceable joystick part can give a competitive advantage to the player. The player can repair a broken button or switch or joystick, and continue to compete in a timed competition with the repaired equipment. Further, during competition after seeing the competitor's game controller, a player can more easily upgrade the buttons and switches to a set of buttons and switches that provide a greater competitive advantage. Further, the interchangeability aspect provides more functional joystick, buttons, and secret signal buttons.

In some embodiments, a first contact panel operatively connects to the first finger actuatable member 112. The first contact panel is configured to selectively engage and disengage the input signal contact member 110 dependent on finger actuation by the first finger actuatable member 112. In this manner, the first contact panel actuates the input signal contact member 110 to transit the input signal when engaging the input signal contact member 110. In one embodiment, the first contact panel is a metal strip that completes the circuit with the metal input signal contact member 110.

The first finger actuatable member 112 may include multiple buttons, switches, and joysticks in any combination. However in some embodiments, the finger actuatable member 112, 114 may include, without limitation, a button, a joystick, an analogue control stick, an adjustable tension stick, a bumper, a track ball, a switch, a trigger, a mouse, a steering wheel, a light gun, a keyboard, and any input device designed for gaming that can receive input. These various input devices may be combined in any combination to form any of the finger actuatable members 112, 114, 128, 138 described herein.

In another exemplary embodiment, the finger actuatable members 112, 114, 128, 138 comprise numerous actions buttons having individual markings thereon, e.g., a triangle, circle square, cross, etc. It is significant to note that there does not need to be four action buttons, there can be as many or few action buttons and switches as desired. For example, there may be one or more action buttons.

FIG. 2 illustrates a first finger actuatable member 112 having four large, spaced-apart buttons 130a-d. Each button is the same size and a generally oval shape forms from the buttons. FIG. 3 illustrates a second finger actuatable member 114 having two large buttons 132a, 132b, and four small buttons 132c-f that form a circle shape. The second finger actuatable member 114 operates similarly to the first finger actuatable member 112, except that more functions are possible since a greater number of buttons are available.

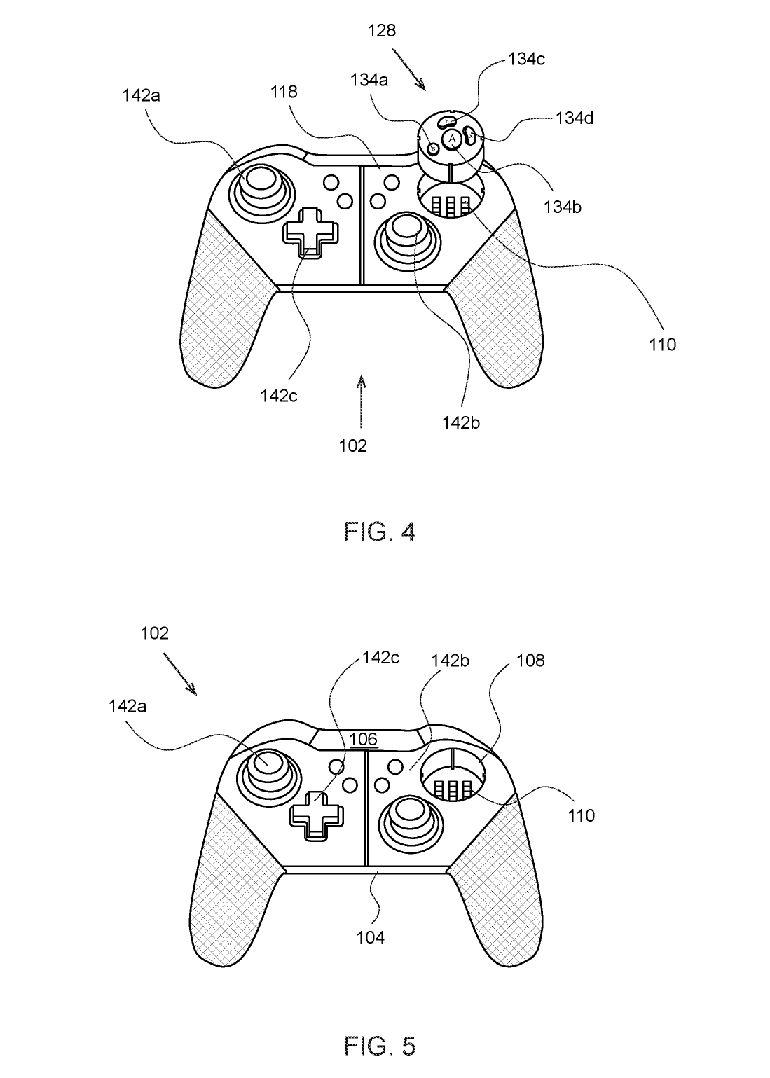

Thus interchanging the first finger actuatable member 112 for the second finger actuatable member 114 to achieve these expansion of buttons may be useful for more complex video games that require additional action. FIG. 4 illustrates a third finger actuatable member 128 having a central large button 134a, a side small button 134b, and two arc-shaped buttons 134c, 134d. Once again, the buttons in all three finger actuatable members perform functions, but for different video games and in different manners. Though not illustrated, joysticks, track balls, and other input devices may have been used with any of the aforementioned finger actuatable members 112, 114, 128, 138.

As FIG. 5 shows, all three of the cited finger actuatable members 112, 114, 128 are interchangeable, depending on the type of video game, or the required functions for the video game, or possible for a desired button combination. In each example, the housing 104 includes at least one fixed joystick or fixed buttons, and such. Though any combination of detachable finger actuatable members and fixed joysticks and buttons may be used. In alternative embodiments, the device 100 comprises a third finger actuatable member 128, and a fourth finger actuatable member 138. Though any number of finger actuatable members may be interchanged with the game controller 102.

In one embodiment, shown in FIG. 7, a rear finger actuatable member 116a, 116b is disposed on the housing 104, opposite the first finger actuatable member 112 or the second finger actuatable member 114. The rear finger actuatable member 116a, 116b is configured such that finger actuation engages the input signal contact member 110, which controls video game activity on the game console. This operating function is similar to the first, second, third, and fourth finger actuatable members 112, 114, 128, 138.

In one non-limiting embodiment, the rear finger actuatable member 116a-b may include two symmetrically disposed switches that align with the thumbs when holding the housing 104 during operation of the game controller 102.

In another exemplary depiction of a rear finger actuatable member 116a, 116b, a first back control and a second back control are provided, with each back control being located on the back of the housing 104 and each back control including an elongate member that extends substantially the full distance between the top edge and the bottom edge and is inherently resilient and flexible. However, similar to the frontally disposed finger actuatable members, the rear finger actuatable member may utilize any combination of buttons, joysticks, track balls, and the like may be used. Furthermore, in some embodiments the rear finger actuatable member may not be utilized.

As discussed above, the device 100 may further include a second finger actuatable member 114 configured generally different than the first finger actuatable member 112. For example, the various buttons, triggers, joysticks, and such may be shaped differently or have different quantities of each type. However, both finger actuatable members perform functions that are pertinent to playing the video game.

Similar to the first finger actuatable member 112, the second finger actuatable member 114 detachably couples to socket 108. In this manner, either finger actuatable member 112, 114 may be easily interchanged for adapting to various video games and playing requirements.

Also, the second finger actuatable member 114 controls video game activity on the game console with a second contact panel that is operatively connected. The second contact panel, similar to the first contact panel is configured to selectively engage and disengage the input signal contact member 110 dependent on finger actuation by the second finger actuatable member 114. However, since the second contact panel engages the input signal contact member 110 in a different region, the input signal, and thereby the function is different. In this manner, the second contact panel actuates the input signal contact member 110 to transit the input signal when engaging the input signal contact member 110 differently than the first finger actuatable member 112.

Looking now at FIG. 8, the device 100 further comprises a plurality of function panels 118. The function panels 118 are interchangeable through detachable coupling to the housing 104. The function panels 118 are configured to detachably overlay the first finger actuatable member 112, the second finger actuatable member 114, the third finger actuatable member 128, and the fourth finger actuatable member 128, while their respective finger actuatable members 112, 114, 128, 138 are detachably coupled to the socket 108. In this manner, each function panel 118 is configured to be operable with a correlating finger actuatable member 112, 114, 128, 138.

In some embodiments, the function panels 118 comprise a flanged perimeter 124, and a surface 120 defined by an opening 126. The flanged perimeter 124 engages a periphery of the housing sidewall 106 to securely fasten the finger actuatable member 112, 114, 128, 138 to the housing 104. In one embodiment, the flanged perimeter 124 has a friction fit relationship with the at least one socket 108.

Further, the opening 126 that forms in the function panel 118 is sized and dimensioned to enable access to the finger actuatable members 112, 114, 128, 138, such that the finger actuatable members pass through the opening 126 and are exposed for manipulation by the fingers and thumbs. In one embodiment, multiple openings are used for each function panel 118, so as to correlate to a differently sized and dimensioned finger actuatable members.

In some embodiments, the function panels 118 comprise a surface 120 having at least one indicia 122a-c. The indicia 122a-c may include, without limitation, graphical images 122a, colors, and text 122b, 122c. The indicia 122a-c on the function panels 118 helps identify at least one of the following: operating functions for each finger actuatable member 112, 114, 128, 138; playing instructions for the video game; the correlation between the finger actuatable members and the video game; and a button combination specific to a finger actuatable member.

For example, in FIG. 9, the indicia 122a-c includes a “view” function that correlates with button X; a “run” function that correlates with button Y; a “jump” function that correlates to button B; and a “kick” function that correlates to button A. However in other embodiments, different function panels are interchangeable through detachable coupling to the housing 104.

In one possible embodiment, the indicia 122a-c includes is configured to display a secret signal command. The secret signal is a label that allows a user to depress certain combinations of buttons or switches to create a secret sequence of commands that can only be accessed by installing and using the button indicia, or special button pads. This provides a game advantage for the user.

In any case, the function panels 118 are configured to detachably overlay the first finger actuatable member 112, the second finger actuatable member 114, the third finger actuatable member 128, and the fourth finger actuatable member 128, while their respective finger actuatable members 112, 114, 128, 138 are detachably coupled to the socket 108.

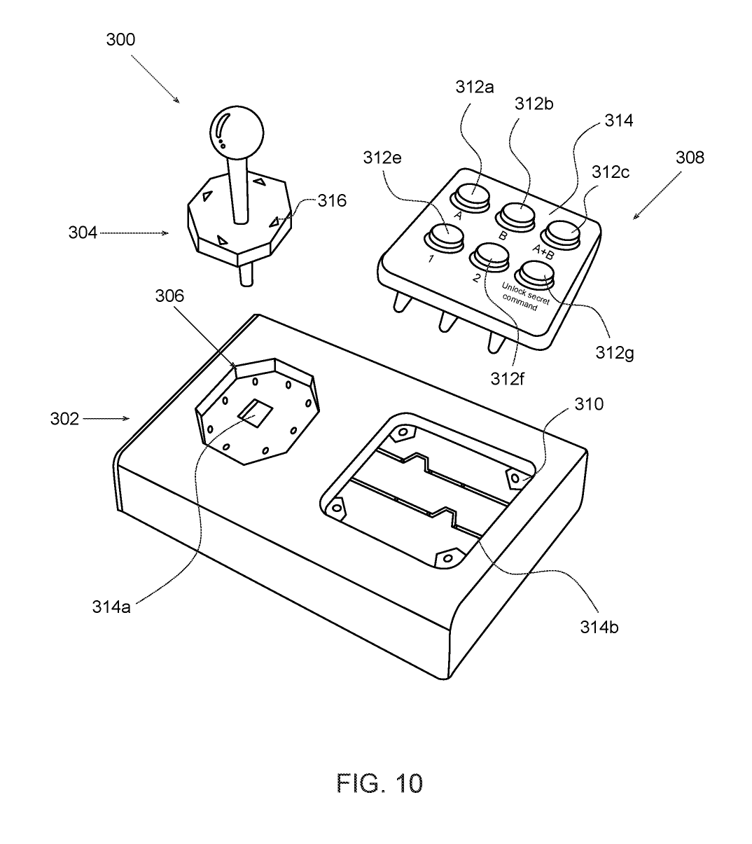

FIG. 10 illustrates an alternative embodiment of a game controller device 300, showing a joystick 304 and six combinations of buttons 312a-f. In one non-limiting embodiment, the game controller device 300 comprises a hand held housing 302 forming a joystick socket 306 and a button socket 310. At least one input signal contact member 314a, 314b in the sockets 306, 310 is operable to transmit a signal to the game console 200. The joystick 304 and the buttons 312a-f can be used in conjunction, or independently of each other.

An interchangeable finger actuatable member 308 comprises six buttons 312a-f that selectively engage and disengage the input signal contact member 314b, such that finger actuation of the buttons 312a-f transmits signals to the game console 200. A button indicia 314 provides a label that indicates the function for each button. For example, a combination of multiple signals or a complex signal order are labeled into one button press (See button A+B shown in FIG. 10).

The device 300 is unique in that the buttons 312a-f may be configured to adapt to different users. For example, a child size button may be smaller and have a button indicia, or layout that allows children's hands to reach all the buttons and switches. For elderly users, larger buttons may be used. Further, a secret signal command may be used by depressing certain combinations of buttons to create a secret sequence of commands that can only be accessed by installing and using the button indicia, or special button pads. This provides a game advantage for the user.

In yet another embodiment, the button indicia 314 may include a title and/or character label, or game insignia for identifying the associated game as related to the button or switches. For example, a drawing of game logo “Super Punch Master” and the illustration of the Punch Master character are shown in FIG. 10.

Similarly the joystick 304 selectively engage and disengage the input signal contact member 314a, such that movement of the joystick in multiple directions transmits signals to the game console 200. A joystick indicia 316 may include arrows that indicate that the joystick can be moved in four directions: up, down, left, and right. Similar to the button indicia 314, a secret combination of joystick 304, or joystick 304 and button 312a-f combinations may be manipulated to create a secret sequence of commands that can only be accessed by installing and using the joystick indicia 316 and button indicia 314.

In operation, the game console 200 is connected to a video game and powered on. The game controller is adapted with one of the finger actuatable members 112, 114, 128, 138 that are detachably coupled to the socket 108. The player may decide the type of finger actuatable members 112, 114, 128, 138 to use based on the game being played. The desired finger actuatable members 112, 114, 128, 138 is detachably inserted into the socket that forms in the housing of the game controller.

Next, the function panels 118 are detachably overlayed onto the housing of the game controller, such that the first finger actuatable member 112, the second finger actuatable member 114, the third finger actuatable member 128, or the fourth finger actuatable member 128 is visible and accessible to the fingers and thumbs. The player uses the indicia on the surface of the function panel 118 to identify the appropriate function to use for playing the video game. The buttons and switches 130a-b for each respective finger actuatable members 112, 114, 128, 138 is manipulated to control functions on the game.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A multi-functional game controller device with interchangeable finger actuatable members and function panels, the device comprising:
a game controller operatively connected to a game console, the game controller defined by a housing, the housing having sidewalls forming at least one socket;
an input signal contact member disposed in the socket, the input signal contact member operable to transmit a signal to the game console;
a first finger actuatable member detachably inserted in the socket, the first finger actuatable member comprising at least one button, or at least one switch, or both, the button or the switch having a first contact panel being selectively engaged with the input signal contact member, dependent on finger actuation of the button or the switch of the first finger actuatable member,
whereby finger actuation of the button or the switch transmits the signal to the game console;
a first contact panel operatively connected to the button or switch of the first finger actuatable member, the first contact panel selectively engaging and disengaging the input signal contact member in the socket, dependent on finger actuation of the button or the switch of the first finger actuatable member,
whereby the first contact panel actuates the input signal contact member to transit the input signal when engaging the input signal contact member;
a plurality of function panels detachably overlaying the housing of the game controller, the function panels defined by a flanged perimeter and a surface forming an opening, the flanged perimeter detachably coupling the function panels to the housing of the game controller, the opening enabling access to the button or the switch of the first finger actuatable member; and
at least one indicia disposed on the surface of the function panels, the indicia generally aligned with the button or the switch, or both, the indicia identifying a function for a correlating button or switch.

2. The device of claim 1, wherein the housing is defined by a generally cross shape.

3. The device of claim 1, further comprising at least one joystick.

4. The device of claim 1, further comprising a rear finger actuatable member disposed in the housing, opposite the first finger actuatable member, the rear finger actuatable member being selectively engaged with the input signal contact member, dependent on finger actuation, whereby finger actuation of the rear finger actuatable member transmits the signal to the game console.

5. The device of claim 4, wherein the first finger actuatable member and the rear finger actuatable member include at least one of the following: a rear joystick, an analogue control stick, an adjustable tension stick, a bumper, a track ball, a switch, a trigger, a mouse, a steering wheel, a light gun, a keyboard, and a peripheral that selectively engages and disengages the input signal contact member in the socket.

6. The device of claim 1, wherein the input signal contact member comprises an electrically conductive strip of metal.

7. The device of claim 1, wherein the indicia on the surface of the function panel includes at least one of the following: a graphical image, a color, a pattern, a texture, a text, and an alphanumeric digit.

8. The device of claim 1, wherein the flanged perimeter of the function panels has a friction fit relationship with the socket forming in the housing of the game controller.

9. The device of claim 1, wherein the engagement between the input signal contact member and the first contact panel closes an electrical circuit.

10. The device of claim 1, further comprising a second finger actuatable member.

11. The device of claim 10, wherein the second finger actuatable member is detachably inserted in the socket, the second finger actuatable member comprising at least one button, or at least one switch, or both, the button or the switch of the second finger actuatable member having a second contact panel being selectively engaged with the input signal contact member, dependent on finger actuation of the button or the switch of the second finger actuatable member.

12. The device of claim 11, wherein finger actuation of the button or the switch of the second finger actuatable member transmits the signal to the game console.

13. The device of claim 12, further comprising a third finger actuatable member and a fourth finger actuatable member.

14. The device of claim 13, wherein the button and switch arrangement for the first, second, third, and fourth finger actuatable members is different.

15. The device of claim 1, wherein the game console is a video game console having a library of video games.

16. A multi-functional game controller device with interchangeable finger actuatable members and function panels, the device comprising:
a game controller operatively connected to a game console, the game controller defined by a housing, the housing having sidewalls forming at least one socket;
an input signal contact member disposed in the socket, the input signal contact member operable to transmit a signal to the game console;
a first finger actuatable member detachably inserted in the socket, the first finger actuatable member comprising at least one button, or at least one switch, or both, the button or the switch having a first contact panel being selectively engaged with the input signal contact member, dependent on finger actuation of the button or the switch of the first finger actuatable member,
whereby finger actuation of the button or the switch transmits the signal to the game console;
a first contact panel operatively connected to the button or switch of the first finger actuatable member, the first contact panel selectively engaging and disengaging the input signal contact member in the socket, dependent on finger actuation of the button or the switch of the first finger actuatable member,
whereby the first contact panel actuates the input signal contact member to transit the input signal when engaging the input signal contact member;
a second finger actuatable member detachably inserted in the socket, the second finger actuatable member comprising at least one button, or at least one switch, or both, the button or the switch having a second contact panel being selectively engaged with the input signal contact member, dependent on finger actuation of the button or the switch of the second finger actuatable member,
whereby finger actuation of the button or the switch of the second finger actuatable member transmits the signal to the game console;
a plurality of function panels detachably overlaying the housing of the game controller, the function panels defined by a flanged perimeter and a surface forming an opening, the flanged perimeter detachably coupling the function panels to the housing of the game controller, the opening enabling access to the button or the switch of the first finger actuatable member and the second finger actuatable member; and
at least one indicia disposed on the surface of the function panels, the indicia generally aligned with the button or the switch of the first or second finger actuatable member, the indicia identifying a function for a correlating button or switch.

17. The device of claim 16, further comprising at least one joystick.

18. The device of claim 16, further comprising a third finger actuatable member and a fourth finger actuatable member.

19. The device of claim 18, further comprising a rear finger actuatable member disposed in the housing, the rear finger actuatable member being disposed opposite the first, second, third, and fourth finger actuatable members, the rear finger actuatable member being selectively engaged with the input signal contact member, dependent on finger actuation, whereby finger actuation of the rear finger actuatable member transmits the signal to the game console.

20. A multi-functional game controller device with interchangeable finger actuatable members and function panels, the device consisting of:
a game controller operatively connected to a game console, the game controller defined by a housing, the housing having sidewalls forming at least one socket;
an input signal contact member disposed in the socket, the input signal contact member operable to transmit a signal to the game console;
a first finger actuatable member detachably inserted in the socket, the first finger actuatable member comprising at least one button, or at least one switch, or both, the button or the switch having a first contact panel being selectively engaged with the input signal contact member, dependent on finger actuation of the button or the switch of the first finger actuatable member,
whereby finger actuation of the button or the switch transmits the signal to the game console;
a first contact panel operatively connected to the button or switch of the first finger actuatable member, the first contact panel selectively engaging and disengaging the input signal contact member in the socket, dependent on finger actuation of the button or the switch of the first finger actuatable member,
whereby the first contact panel actuates the input signal contact member to transit the input signal when engaging the input signal contact member;
a second finger actuatable member detachably inserted in the socket, the second finger actuatable member comprising at least one button, or at least one switch, or both, the button or the switch having a second contact panel being selectively engaged with the input signal contact member, dependent on finger actuation of the button or the switch of the second finger actuatable member,
whereby finger actuation of the button or the switch of the second finger actuatable member transmits the signal to the game console;
a third finger actuatable member detachably inserted in the socket, the third finger actuatable member comprising at least one button, or at least one switch, or both, the button or the switch being selectively engaged with the input signal contact member, dependent on finger actuation of the button or the switch of the third finger actuatable member;
a fourth finger actuatable member detachably inserted in the socket, the fourth finger actuatable member comprising at least one button, or at least one switch, or both, the button or the switch being selectively engaged with the input signal contact member, dependent on finger actuation of the button or the switch of the fourth finger actuatable member,
whereby the button and switch arrangement for the first, second, third, and fourth finger actuatable members is different;
at least one joystick;
a plurality of function panels detachably overlaying the housing of the game controller, the function panels defined by a flanged perimeter and a surface forming an opening, the flanged perimeter detachably coupling the function panels to the housing of the game controller, the opening enabling access to the button or the switch of the first, second, third, and fourth finger actuatable members; and
at least one indicia disposed on the surface of the function panels, the indicia generally aligned with the button or the switch of the first, second, third, and fourth finger actuatable members, the indicia identifying a function for a correlating button or switch, the indicia including at least one of the following: a graphical image, a color, a pattern, a texture, a text, and an alphanumeric digit.
